(19) United States
(12) Patent Application Publication
(10) Pub. No.: US 2025/0102878 A1
(43) Pub. Date: Mar. 27, 2025

(54) GERMANIUM AOD SYSTEM WITH PARALLEL AND PERPENDICULAR ORIENTATIONS

(71) Applicant: ELECTRO SCIENTIFIC INDUSTRIES, INC., BEAVERTON, OR (US)

(72) Inventors: James BROOKHYSER, Andover, MA (US); Jan KLEINERT, Andover, MA (US)

(73) Assignee: ELECTRO SCIENTIFIC INDUSTRIES, INC., BEAVERTON, OR (US)

(21) Appl. No.: 18/729,604

(22) PCT Filed: Dec. 5, 2022
(86) PCT No.: PCT/US2022/051815

§ 371 Date: Jul. 17, 2024

Related U.S. Application Data
(60) Provisional application No. 63/304,349, filed on Jan. 28, 2022.
(60) Provisional application No. 63/384,539, filed on Nov. 21, 2022.

(51) Int. Cl. G02F 1/33

(52) U.S. Cl. CPC G02F 1/33

(57) ABSTRACT

Numerous examples of a multi-axis beam positioner operative to deflect a beam path along which laser light along multiple axes are disclosed. The beam positioner includes a first AOD and a second AOD arranged optically in series with each other. The first and second AODs are arranged and configured to deflect the beam path along a different axes of the multi-axis beam positioner. In one example, AO cell of the first AOD and is formed from the same material as the AO cell of the second AOD but the first AOD is configured differently from the second AOD. In other example, the first AOD and the second AOD are longitudinal-mode AODs and no retarder is present between the first and second AODs. In other example, a heat exchanger is provided to cool the AO cell of the second AOD relative to the AO cell of the first AOD.

### BACKGROUND

### I. Technical Field

Embodiments of the present invention relate generally to acousto-optic deflectors, beam positioning systems incorporating the same, and techniques of operating the same.

### II. Discussion of the Related Art

Acousto-optic (AO) devices, sometimes referred to as Bragg cells, diffract and shift light using acoustic waves at radio frequency. These devices are often used for Q-switching, signal modulation in telecommunications systems, laser scanning and beam intensity control in microscopy systems, frequency shifting, wavelength filtering in spectroscopy systems. Many other applications lend themselves to using acousto-optic devices. For example, AO deflectors (AODs) can be used in laser-based materials processing systems.

In a typical AO device, a transducer is attached to an AO medium (also referred to as an “AO cell”), typically a crystal or glass that is suitably transparent to the wavelength of light to be diffracted. An RF signal (also known as a “drive signal”) is applied to the transducer (e.g., from an RF driver), thereby driving the transducer to vibrate at a certain frequency; propagating an acoustic wave into the AO medium, manifested as periodic regions of expansion and compression in the AO medium, thereby creating a periodically changing refractive index within the AO medium. The periodically changing refractive index functions like an optical grating that can diffract a beam of laser light propagating through the AO medium.

Referring to FIG. 1, an AOD 100 generally includes AO medium 102, a transducer 104 attached to the AO medium 102 (i.e., at a transducer end of the AO medium 102) and, can also include an acoustic absorber 106 attached to the AO medium 102 (i.e., at an absorber end of the AO medium 102, opposite the transducer end). Although FIG. 1 illustrates a configuration in which only a single transducer 104 is attached to the AO medium 102, it will be appreciated that multiple transducers 104 (e.g., arranged in a linear array) can be attached to the AO medium 102 at the transducer end thereof. An RF driver 108 is electrically coupled to an input of each transducer 104 to drive the AOD 100. The material from which the AO medium 102 is formed is selected depending on the wavelength of light in the beam of laser light to be deflected. Transducers 104 are generally formed of piezoelectric material, and are operative to vibrate in response to an input RF signal output by the RF driver 108. The RF driver 108 is operative to generate the drive signal that is ultimately input to the transducer 104.

Generally, each transducer 104 is attached to the AO medium 102 such that vibrations generated by the transducer 104 can create a corresponding acoustic wave (e.g., a longitudinal mode acoustic wave, as indicated by lines 112) that propagates within the AO medium 102, from the transducer end toward the acoustic absorber 106 along a diffraction axis (indicated by arrow 110) of the AOD 100. As exemplarily illustrated in FIG. 1, when an RF drive signal (e.g., characterized by a frequency, amplitude, phase, etc.) is applied to a transducer 104, the transducer 104 vibrates to create an acoustic wave propagating within the AO medium 102, thereby generating a periodically changing refractive index within the AO medium 102. As is known in the art, the periodically changing refractive index functions to diffract a beam of laser light (e.g., propagating along beam path 114) that is incident upon a first surface 102a of the AO medium 102 and propagates through the AO medium 102 at the Bragg angle, θB, measured relative to the acoustic wave.

Diffracting the incident beam of laser light produces a diffraction pattern that typically includes zeroth- and first-order diffraction peaks, and may also include higher-order diffraction peaks (e.g., second-order, third-order, etc.). As is known in the art, the portion of the diffracted beam of laser light in the zeroth-order diffraction peak is referred to as a “zeroth-order” beam, the portion of the diffracted beam of laser light in the first-order diffraction peak is referred to as a “first-order” beam, and so on. Generally, the zeroth-order beam and other diffracted-order beams (e.g., the first-order beam, etc.) propagate along different beam paths upon exiting the AO medium 102 (e.g., through a second surface 102b of the AO medium 102, opposite the first surface 102a). For example, the zeroth-order beam propagates along a zeroth-order beam path, the first-order beam propagates along a first-order beam path, and so on. The angles between the zeroth- and other diffracted-order beam paths (e.g., the angle, θD, between the zeroth- and first-order beam paths) corresponds to the frequency (or frequencies) in the drive signal that was applied to diffract the beam of laser light incident upon the AO medium 102.

The amplitude of the applied drive signal (i.e., the amount of power in the applied drive signal) can have a non-linear effect on the proportion of the incident beam of laser light that gets diffracted into the various diffracted-order beams, and an AOD can be driven to diffract a significant portion of an incident beam of laser light into the first-order beam, leaving a relatively small portion of the incident beam of laser light to remain in other diffracted-order beams (e.g., the zeroth-order beam, etc.). Moreover, the frequency of the applied drive signal can be rapidly changed to scan first-order beam (e.g., to facilitate processing of different regions of a workpiece). Thus AODs are advantageously incorporated into laser processing systems for use within the field of laser-based materials processing, to variably deflect the first-order beam onto a workpiece during processing (e.g., melting, vaporizing, ablating, marking, cracking, etc.) of the workpiece.

Laser processing systems typically include one or more beam dumps to prevent laser light propagating along the zeroth-order beam path (and any higher-order beam paths) from reaching the workpiece. Accordingly, within a laser processing system, the first-order beam path exiting the AOD 100 can typically be regarded as the beam path 114 that has been rotated or deflected (e.g., by angle, θD, also referred to herein as “first-order deflection angle”) within the AOD 100. The axis about which the beam path 114 is rotated (also referred to herein as the “rotation axis”) is orthogonal to the diffraction axis of the AOD 100 and an axis along which the incident beam of laser light propagates (also referred to herein as the “optical axis”) within the AOD 100 when the AOD 100 is driven to diffract the incident beam of laser light. The AOD 100 thus deflects an incident beam path 114 within a plane (also referred to herein as a “plane of deflection”) that contains (or is otherwise generally parallel to) the diffraction axis of the AOD 100 and the optical axis within the AOD 100. The spatial extent across which the AOD 100 can deflect the beam path 114 within the plane of deflection is herein referred to as the “scan field” of the AOD 100.

Laser processing systems can incorporate multiple AODs, arranged in series, to deflect the beam path 114 along two axes. For example, and with reference to FIG. 2, a first AOD 200 and a second AOD 202 can be oriented such that their respective diffraction axes (i.e., a first diffraction axis 200a and a second diffraction axis 202a, respectively) are oriented perpendicular to one another. In this example, the first AOD 200 is operative to rotate the beam path 114 about a first rotation axis 200b (e.g., which is orthogonal to the first diffraction axis 200a), thus deflecting the incident beam path 114 within a first plane of deflection (i.e., a plane that contains, or is otherwise generally parallel to, the first diffraction axis 200a and the optical axis within the first AOD 200), wherein the first plane of deflection is orthogonal to the first rotation axis 200b. Likewise, the second AOD 202 is operative to rotate the beam path 114 about a second rotation axis 202b (e.g., which is orthogonal to the second diffraction axis 202a), thus deflecting the incident beam path 114 within a second plane of deflection (i.e., a plane that contains, or is otherwise generally parallel to, the second diffraction axis 202a and the optical axis within the second AOD 202), wherein the second plane of deflection is orthogonal to the second rotation axis 202b. In view of the above, the first and second AODs 200 and 202 can be collectively characterized as a multi-axis “beam positioner,” and each can be selectively operated to deflect the beam path 114 within a two-dimensional scan field 204. As will be appreciated, the two-dimensional range scan field 204 can be considered to be a superposition of two one-dimensional scan fields: a first, one-dimensional scan field associated with the first AOD 200 and a second, one-dimensional scan field associated with the second AOD 202.

Depending on the type of AODs included in the multi-axis beam positioner, it can be desirable to rotate the plane of polarization of light (i.e., the plane in which the electric field oscillates) in the first-order beam path transmitted by the first AOD 200. Rotating the plane of polarization will be desired if the amount of RF drive power required to diffract significant portion of an incident beam of laser light into the first-order beam is highly dependent on the polarization state of the beam of laser light being deflected. Further, if each AOD in the multi-axis beam positioner includes an AO medium 102 formed of the same material, and if each AOD uses the same type of acoustic wave (e.g., longitudinal-mode acoustic waves) to deflect an incident beam of laser light, and if it is desirable to have the polarization state of light in the first-order beam transmitted by the first AOD 200 be linear and be oriented in a particular direction relative to the second diffraction axis 202a, then it would be similarly desirable to have the polarization state of light in the first-order beam transmitted by the second AOD 202 be rotated with respect to the polarization state of the light in the first-order beam transmitted by the first AOD 200 just as the orientation of the second AOD 202 is rotated with respect to an orientation of the first AOD 200. Thus when the conditions set forth above are satisfied, some polarization rotation mechanism (not shown) will be arranged in the beam path 114 between the first AOD 200 and the second AOD 202 to rotate the plane of polarization of the beam of laser light output by the first AOD 200.

One of ordinary skill will recognize that the material from which an AO cell of an AOD is formed can vary depending upon the wavelength of the beam of laser light that is to be diffracted therein. For a beam of laser light having a wavelength in the long-wave infrared (LWIR) range of the electromagnetic spectrum (also referred to herein as an “LWIR beam of laser light”), the AO cell of an AOD is formed of crystalline germanium. Thus if the AO cell of the first AOD 200 is formed of crystalline germanium, then the plane of polarization of laser light incident upon the first AOD 200 should be parallel to (or at least substantially parallel to) the first diffraction axis 200a and will also be parallel to (or at least substantially parallel to) the plane of polarization of laser light that is output (e.g., along the beam path 114) from the first AOD 200. Likewise, if the AO cell of the second AOD 202 is formed the same material as that of the first AOD 200 (i.e., crystalline germanium), then the plane of polarization of laser light incident upon the second AOD 202 should be parallel to (or at least substantially parallel to) the second diffraction axis 202a and will also be parallel to (or at least substantially parallel to) the plane of polarization of laser light that is output (e.g., along the beam path 114) from the second AOD 202. Thus, it would be desirable to rotate the plane of polarization of laser light output (e.g., along the beam path 114) from the first AOD 200, which is parallel to (or at least substantially parallel to) the first diffraction axis 200a, to be parallel to (or at least substantially parallel to) the second diffraction axis 200b before it is incident upon the second AOD 202.

Generally, when the wavelength of the beam of laser light is in the ultraviolet, visible or near infrared (NIR) ranges of the electromagnetic spectrum, the polarization rotation is easily accomplished using a transmissive half-wave plate, as is known in the art. The orientation of polarization after the half-wave plate relative to the incident beam of laser light is a function of the orientation of the half-wave plate relative to the polarization orientation of the incident beam of laser light. However, when the wavelength of the beam of laser light is in the LWIR beam of laser light, polarization rotation cannot be accomplished using simple transmissive half-wave plates. Instead, one or more reflective phase retarding (RPR) mirrors and relay lenses can be used in various arrangements to effect polarization rotation of a LWIR beam of laser light propagating from the first AOD 200 to the second AOD 202. While these arrangements perform adequately, the addition of RPR mirrors and relay lenses increase the complexity and cost of multi-axis beam positioners capable of deflecting LWIR beams of laser light.

### SUMMARY

One embodiment can be broadly characterized as a multi-axis beam positioner operative to deflect a beam path along which laser light along multiple axes, wherein the beam positioner comprises: a first acousto-optic (AO) deflector (AOD) and a second AOD arranged optically in series with each other, wherein the first AOD is arranged and configured to deflect the beam path along a first axis of the multi-axis beam positioner, wherein the second AOD is arranged and configured to deflect the beam path along a second axis of the multi-axis beam positioner, wherein each of the first AOD and the second AOD has an AO cell and a transducer attached to the AO cell, wherein the AO cell of the first AOD and is formed from the same material as the AO cell of the second AOD, and wherein the first AOD is configured differently from the second AOD.

Another embodiment can be broadly characterized as a multi-axis beam positioner operative to deflect a beam path along which laser light along multiple axes, wherein the beam positioner comprises: a first acousto-optic (AO) deflector (AOD) and a second AOD arranged optically in series with each other, wherein the first AOD is arranged and configured to deflect the beam path along a first axis of the multi-axis beam positioner, wherein the second AOD is arranged and configured to deflect the beam path along a second axis of the multi-axis beam positioner, wherein each of the first AOD and the second AOD has an AO cell and a transducer attached to the AO cell, wherein the first AOD and the second AOD are longitudinal-mode AODs, and wherein no retarder is present between the first AOD and the second AOD.

Yet another embodiment can be broadly characterized as a multi-axis beam positioner that includes: a first acousto-optic (AO) deflector (AOD) and a second AOD arranged optically in series with each other; and a heat exchanger coupled to the second AOD, wherein the first AOD is arranged and configured to deflect the beam path along a first axis of the multi-axis beam positioner, wherein the second AOD is arranged and configured to deflect the beam path along a second axis of the multi-axis beam positioner, wherein each of the first AOD and the second AOD has an AO cell and a transducer attached to the AO cell, wherein the AO cell of the second AOD is formed of crystalline germanium, and wherein the at least one heat exchanger is configured to maintain the AO cell of the second AOD at a temperature that is less than a temperature of the AO cell of the first AOD.

### BRIEF DESCRIPTION OF THE DRAWINGS

FIG. 1 schematically illustrates an acousto-optic deflector (AOD) and an operation thereof.

FIG. 2 schematically illustrates a multi-axis beam positioner incorporating pair of AODs arranged optically in series.

FIGS. 3, 4 and 7 schematically illustrate multi-axis beam positioners according to some embodiments of the present invention.

FIG. 5 illustrates a graph of measured thermal conductivity of germanium at low temperatures.

FIG. 6 illustrates a graph of acoustic attenuation of longitudinal and shear acoustic waves in germanium at low temperatures.

### DETAILED DESCRIPTION

Example embodiments are described herein with reference to the accompanying FIGS. Unless otherwise expressly stated, in the drawings the sizes, positions, etc., of components, features, elements, etc., as well as any distances therebetween, are not necessarily to scale, but are exaggerated for clarity.

The terminology used herein is for the purpose of describing particular example embodiments only and is not intended to be limiting. As used herein, the singular forms “a,” “an” and “the” are intended to include the plural forms as well, unless the context clearly indicates otherwise. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise specified, a range of values, when recited, includes both the upper and lower limits of the range, as well as any sub-ranges therebetween. Unless indicated otherwise, terms such as “first,” “second,” etc., are only used to distinguish one element from another. For example, one node could be termed a “first node” and similarly, another node could be termed a “second node”, or vice versa. The section headings used herein are for organizational purposes only and are not to be construed as limiting the subject matter described.

Unless indicated otherwise, the term “about,” “thereabout,” “substantially,” etc., means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Spatially relative terms, such as “below,” “beneath,” “lower,” “above,” and “upper,” and the like, may be used herein for ease of description to describe one element or feature's relationship to another element or feature, as illustrated in the FIGS. It should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly.

Like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

It will be appreciated that many different forms and embodiments are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

Rather than using relatively expensive and complex arrangements of RPRs and relay lenses to rotate the plane of polarization between AODs of a multi-axis beam positioner (i.e., capable of deflecting a LWIR beam of laser light), embodiments of the present invention avoid the need for polarization rotation altogether by designing the first and second AODs differently from one another, or by operating them differently. Thus a multi-axis beam positioner can be provided in which no RPRs or other transmissive wave plate(s) (generically referred to herein as “retarders”) is present between the first and second AODs. In addition to simplifying the complexity of the beam path between the AODs, the multi-axis beam positioner can be assembled faster and operated more reliably by omitting the polarization rotation mechanism. Likewise, the overall optical transmission of the multi-axis beam positioner can be increased by omitting the polarization rotation mechanism between the AODs.

In the embodiments discussed below, each of the first AOD 200 and the second AOD 202 can be provided as “longitudinal-mode” or “isotropic” AODs, in which the longitudinal acoustic waves propagate through the AO cells thereof so that the incident and diffracted beams of laser light see the same (or substantially the same) refractive index within the AO cell and the polarization of the incident beam of laser light is the same as (or substantially the same as) the polarization of the diffracted beams of laser light. Furthermore, in the embodiments discussed below, the AO cell of each of the first AOD 200 and the second AOD 202 is formed of crystalline germanium. As used herein, when the plane of polarization of laser light incident upon an AOD is parallel to (or at least substantially parallel to) the diffraction axis of the AOD, then the AOD can be considered to be in a “parallel operative state.” Likewise, when the plane of polarization of laser light incident upon an AOD is perpendicular to (or at least substantially perpendicular to) the diffraction axis of the AOD, then the AOD can be considered to be in a “perpendicular operative state.”

### I. Embodiment 1

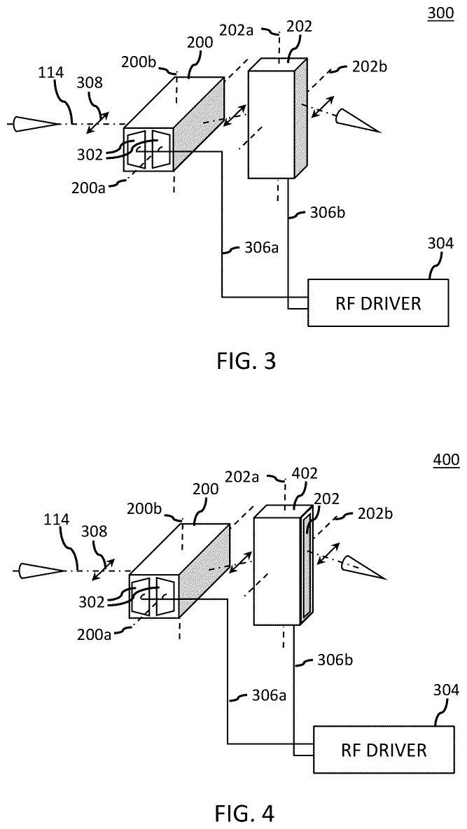

Referring to FIG. 3, a multi-axis beam positioner 300 according to one embodiment of the present invention includes a first AOD 200 and a second AOD 202 arranged, optically, in series as exemplarily described with respect to FIG. 2. As noted above, the AO cells of the first AOD 200 and the second AOD 202 are formed of the same material (i.e., crystalline germanium). According to the present embodiment, however, the AO cell of each of the first AOD 200 and the second AOD 202 is cut and assembled into its respective AOD such that the

diffraction axis of the AOD is parallel (or at least substantially parallel) to the [111] crystal axis of the AO cell. Furthermore, the dimensions of the AO cells of the first AOD 200 and the second AOD 202 are the same (or at least substantially the same).

The first AOD 200 includes a first plurality of transducers 302 (e.g., two transducers, as shown, or more than two transducers) attached to the AO cell of the first AOD 200 at a transducer end thereof. Likewise, the second AOD 202 includes a second plurality of transducers (e.g., two or more transducers) attached to the AO cell of the second AOD 202 at a transducer end thereof. Generally, the transducers commonly attached to any AO cell are arranged such that acoustic waves generated by adjacent transducers overlap with one other within the AO cell. The transducers of the AODs are electrically connected to a source of RF power (e.g., driver 304) by one or more respective RF power lines. For example, the first plurality of transducers (e.g., transducers 302) are electrically connected to the driver 304 by a common first RF power line 306a, and the second plurality of transducers are electrically connected to the driver 304 by a common second RF power line 306b.

In the illustrated embodiment, the RF driver 304 is operative to output the same or different RF signals (e.g., in terms of frequency, power or the like or any combination thereof) to the first RF power line 306a and the second RF power line 306b. Thus, it is possible that, during operation of the multi-axis beam positioner 300, the RF signals output to the first RF power line 306a and the second RF power line 306b can be the same as one another or different from one another. In another embodiment, however, the first RF power line 306a and the second RF power line 306b can be electrically connected to different sources of RF power (i.e., to different drivers).

In the illustrated embodiment, the plurality of transducers attached to a common AO cell are all electrically connected a common RF power line. In another embodiment, however, two or more transducers of any plurality of transducers may be electrically connected to different RF power lines. Furthermore, at least two of the different RF power lines may be electrically connected to the same source of RF power or to different sources of RF power (i.e., to the same driver or to different drivers).

Unlike the multi-axis beam positioner discussed above with respect to FIG. 2, the multi-axis beam positioner 300 does not include a mechanism arranged in the beam path 114 between the first AOD 200 and the second AOD 202 to rotate the plane of polarization of the beam of laser light output by the first AOD 200. Rather, one of the first AOD 200 and the second AOD 202 is provided in a parallel operative state whereas the other of the other of the first AOD 200 and the second AOD 202 is provided in a perpendicular operative state. Given the material and configuration of the AO cells discussed above, an RF signal having a relatively low power can be applied to the transducers 302 of the AOD provided in the parallel operative state to cause the AOD to diffract an LWIR laser beam at a relatively high diffraction efficiency. However, an RF signal having a relatively high power must be applied to the transducers 302 of the AOD provided in the perpendicular operative state to cause the AOD to diffract an LWIR laser beam at a similarly high diffraction efficiency.

For purposes of facilitating discussion, the amount of power in an applied RF signal that will cause the AOD to diffract the laser beam at a desirably high diffraction efficiency is also herein referred to as the “effective power,” which may be equal (or almost equal to) to the saturation power AOD (i.e., the amount of power required to achieve maximum diffraction efficiency). Thus, to achieve a desirably diffraction efficiency (e.g., above 95% or thereabout), the effective power of an RF signal applied to transducers of the AOD provided in the parallel operative state will generally be lower than the effective power of an RF signal applied to transducers of the AOD provided in the perpendicular operative state.

Thus, in the context of the example embodiment shown in FIG. 3, the first AOD 200 is provided in the parallel operative state and the second AOD 202 is provided in the perpendicular operative state. In this case, the double-arrow 308 in the beam path 114 represents the plane of polarization of the beam of laser light propagating along beam path 114. As exemplarily illustrated, the plane of polarization of the beam of laser light incident upon each AOD is parallel to (or substantially parallel to) the plane of polarization of the beam of laser light output from AOD along beam path 114. Furthermore, the plane of polarization 308 is parallel to (or substantially parallel to) the first diffraction axis 200a of the first AOD 200 and is perpendicular to (or substantially perpendicular to) the second diffraction axis 202a of the second AOD 202. In this example, an RF signal having a relatively low effective power (e.g., a first effective power) can be applied to each of the transducers 302 of the first AOD 200 to cause the first AOD 200 to diffract an LWIR laser beam at a relatively high diffraction efficiency (e.g., at a first diffraction efficiency). However, an RF signal having a relatively high effective power (e.g., a second effective power) must be applied to each of the transducers of the second AOD 202 to cause the second AOD 202 to diffract an LWIR laser beam at a second diffraction efficiency that is equal to (or about equal to) the first diffraction efficiency. For example, an RF signal having a first effective power of ˜65 W could be applied to each transducer of the first AOD 200 (resulting in ˜130 W of RF power being applied to the first AOD 200) to obtain a desired diffraction efficiency (e.g., 95% or more) from the first AOD 200, and an RF signal having a second effective power in a range of 4 to 20 times that of the first effective power could be applied to each transducer of the second AOD 202 (resulting in ˜260 W to ˜1300 W of RF power being applied to the second AOD 202) to obtain a similarly high diffraction efficiency from the second AOD 202.

### II. Embodiment 2

When applying RF signals having power levels commensurate with the second effective power described above (i.e., in Embodiment 1) to transducers of the AOD, there is a possibility that an undesirably large amount of heat—sufficient to damage the AOD—may be generated. To avoid or minimize the deleterious effects of this heating issue, heat may be extracted from the AOD in the multi-axis beam positioner 300 that is provided in the perpendicular operative state (e.g., the second AOD 202, as shown in FIG. 3) using a cooling jacket or any other suitable or known heat exchange mechanism.

For example, and with reference to FIG. 4, a multi-axis beam positioner 400 according to another embodiment of the present invention may be provided in the same manner as discussed above with respect to the multi-axis beam positioner 300 but further includes a cooling jacket 402 in thermal contact with the second AOD 202 (no cooling jacket is in thermal contact with the first AOD 200). Generally, and proceeding under the assumption that the multi-axis beam positioner 400 is situated in an environment having an ambient temperature at “room temperature” (e.g., at or about 293 K), the cooling jacket is configured to cool the AO crystal of the second AOD 202 to a temperature below 273.15 K.

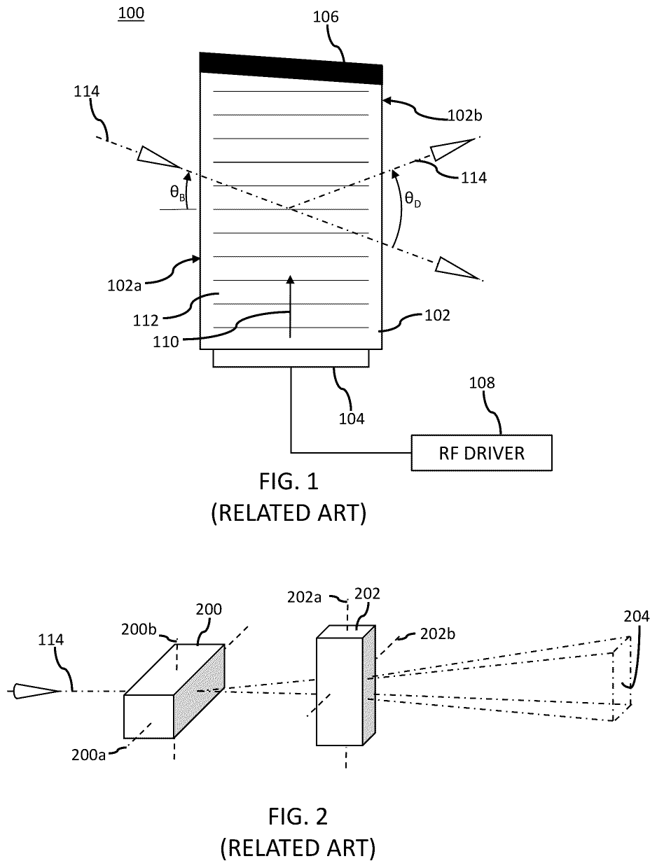

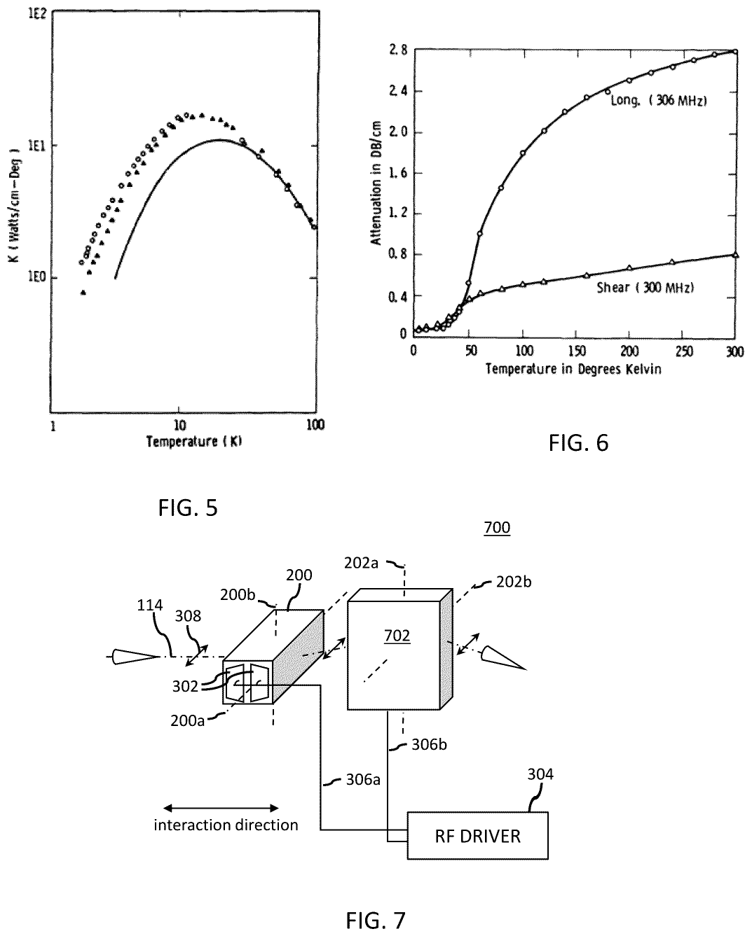

It should be recognized by those of ordinary skill that the thermal conductivity of optical-grade crystalline germanium increases as it is cooled to temperatures below 273.15 K, achieving a maximum thermal conductivity within a temperature range between 10 K (or thereabout) and 50 K (or thereabout) before decreasing at a significant rate upon further cooling below 10 K. See, e.g., FIG. 5, which illustrates the measured thermal conductivity of germanium at low temperatures. It should also be recognized by those of ordinary skill that the crystalline germanium is also less absorptive of longitudinal acoustic waves having ultrasonic frequencies at temperatures below 293 K, achieving relatively low acoustic attenuation at temperatures below 100 K (or thereabout). See, e.g., FIG. 6, which illustrates the acoustic attenuation of longitudinal and shear acoustic waves in germanium at low temperatures. The graphs shown in FIGS. 5 and 6 were obtained from D. R. Suhre, “Multi-Stage Acousto-Optic Modulator,” Proc. SPIE 0999, Laser Radar III, (18 Feb. 1989). In view of the above, the cooling jacket 402 can be configured in any known or suitable manner to cool the second AOD 202 to a temperature significantly below 293 K, such as to a temperature at or below 250 K, at or below 200 K, at or below 150 K, at or below 100 K, at or below 50 K, at 10 K (or thereabout), etc., or between any of these values (e.g., at a temperature between 77 K (or thereabout) and 273.15 K (or thereabout)). In view of the above, the cooling jacket 402 can be generally characterized as including a metal sheath or casing having defined therein one or more fluid channels, each in communication with one or more intake and outtake ports allowing a coolant fluid (e.g., liquid nitrogen, liquid helium, or any other known or suitable refrigerant) to be pumped therethrough, as is known in the art. Optionally, a dehumidifier (not shown) may be provided to prevent moisture in the atmosphere surrounding the second AOD 202 from condensing on any optical surfaces of the second AOD 202 (e.g., corresponding to the first surface 102a and/or second surface 102b discussed above with respect to FIG. 1).

Although the multi-axis beam positioner 400 has been discussed above as including a cooling jacket 402 configured to cool the AO cell of the second AOD 202 as discussed above, it will be appreciated that a cooling jacket may be similarly provided to cool the AO cell of the first AOD 200, even though the first AOD 200 is provided in the parallel operative state.

### III. Embodiment 3

Referring to FIG. 7, a multi-axis beam positioner 700 according to another embodiment of the present invention may be provided in the same manner as discussed above with respect to the multi-axis beam positioner 300 but the interaction length of the AOD provided in the perpendicular orientation state (i.e., the second AOD 202, shown in FIG. 3) is increased to be greater than the interaction length of the AOD provided in the parallel orientation state (i.e., the first AOD 200, shown in FIG. 3). As used herein, the “interaction length” of an AOD refers to the width of the acoustic wave (measured along an axis extending through the AO cell perpendicular to (or otherwise through) the first surface 102a and the second surface 102b; along the direction indicated by the double-arrow labelled “interaction direction”) propagatable through the AO cell of the AOD.

Thus, the AO cell of the second AOD 702 shown in FIG. 7 is formed of the same material as the AO cell of the first AOD 200, and is also cut and assembled into the second AOD 702 such that the diffraction axis of the second AOD 702 is parallel (or at least substantially

parallel) to the [111] crystal axis of the AO cell. However, the length of the AO cell of the second AOD 702, as measured along the direction indicated by the double-arrow labelled “interaction direction”, is greater than the length of the AO cell of the first AOD 200. Furthermore, the second AOD 702 can include more transducers attached to the AO cell thereof (e.g., linearly arranged in a pattern extending along the interaction direction) than the first AOD 200.

According to embodiments of the present invention, the interaction length (also referred to herein as “Lperp”) of the AOD provided in the perpendicular orientation state is at least 1.5 times greater than the interaction length (also referred to herein as “Lpara”) of the AOD provided in the parallel orientation state. That is, Lperp=n*Lpara, wherein n is equal to or greater than 1.5 (e.g., n can be 1.5., 2, 2.5, 3, 4, 5, 10, 15, 20, 30, etc., or between any of these values). In one embodiment, Lpara is in a range from 17 mm to 19 mm.

By increasing the interaction length of the AOD provided in the perpendicular orientation state, the effective power in the RF signal to be applied to each transducer of the AOD can be decreased while still obtaining a desirably high diffraction efficiency from the AOD. Thus, assuming that the RF signal having the second effective power could be applied to each transducer of the second AOD 202 in the multi-axis beam positioner 300 to obtain a desired diffraction efficiency (e.g., 95% or more) from the second AOD 202, a similarly high diffraction efficiency can be obtained from the second AOD 702 by applying RF signal having a third effective power, to each transducer of the second AOD 702. In this case, the third effective power is generally significantly less than the second effective power.

Upon modifying the second AOD 202 to obtain the second AOD 702 having the increased interaction length, the amount of energy in the LWIR beam (also referred to herein as “optical energy”) absorbed by the AO cell will also increase. The increased absorption of optical energy can result in the generation of heat or other thermal gradients within the AO cell, which can damage the AOD or prevent accurate/repeatable beam positioning by the AOD. To avoid or minimize the deleterious effects of this heating issue, the heat may be extracted from the AOD provided in the perpendicular operative state using a cooling jacket or any other suitable or known heat exchange mechanism (e.g., in a similar manner as discussed above with respect to FIG. 4).

For example, the multi-axis beam positioner 700 may optionally include a cooling jacket in thermal contact with the second AOD 702. Generally, and proceeding under the assumption that the multi-axis beam positioner 400 is situated in an environment having an ambient temperature at “room temperature” (e.g., at or about 293 K), the cooling jacket is configured to cool the AO crystal of the second AOD 702 by an amount that, at least partly, corresponds to the interaction length of the second AOD 702 (e.g., relative to the interaction length of the second AOD 202). For example, if the AO cell of the second AOD 702 absorbs double the amount of optical energy than the AO cell of the second AOD 202 (e.g., as a result of the increased interaction length of the second AOD 702 relative to that of the second AOD 202, then the cooling jacket can be configured to cool the AO cell of the second AOD 702 by 20 K (or thereabout), i.e., to a temperature in a range from 273 K (or thereabout) to 278 K (or thereabout), assuming the second AOD 702 is arranged within an environment having an ambient temperature at “room temperature.”

Although the multi-axis beam positioner 700 has been discussed above as including a second AOD 702 having an increased interaction length (relative to the second AOD 202 shown in FIG. 3), it will be appreciated that the first AOD 200 of the multi-axis beam positioner 700 may likewise be modified to have an increased interaction length (e.g., relative to the first AOD 200 shown in FIG. 3). Likewise, a cooling jacket may be similarly provided to cool the AO cell of the first AOD 200 and compensate for any thermal effects created as a result of the increased interaction length.

### IV. Embodiment 4

As used herein, an AOD having the crystalline germanium AO cell cut and assembled thereinto such that the [111] crystal axis of the AO cell is parallel or perpendicular to (or at least substantially parallel or perpendicular to) the diffraction axis of the AOD is herein referred to as an “[111]-oriented AOD.” Likewise, an AOD having the crystalline germanium AO cell cut and assembled thereinto such that the [100] crystal axis of the AO cell is parallel or perpendicular to (or at least substantially parallel or perpendicular to) the diffraction axis of the

AOD is herein referred to as an “[100]-oriented AOD.” A multi-axis beam positioner according to yet another embodiment of the present invention can be provided in any manner as described in any of the embodiments above, but the AO cell of the AOD that is provided in the perpendicular operative state is a [100]-oriented AOD.

When driven at the same RF power, a [100]-oriented AOD provided in a perpendicular operative state can be operated at a higher diffraction efficiency than an otherwise-equivalent [111]-oriented AOD provided in a perpendicular operative state. Thus, if the second AOD 202 shown in FIG. 3 is modified to be provided as a [100]-oriented AOD, then modified second AOD 202 can be operated at an effective power lower than the second effective power to achieve the second diffraction efficiency that is equal to (or about equal to) the first diffraction

efficiency. If the second AOD 202 shown in FIG. 4 is modified to be provided as a [100]-oriented AOD, then the temperature to which the AO cell of the modified second AOD 202 should be cooled down to can be increased. Optionally, if the second AOD 702 shown in FIG. 7 is modified to be provided as a [100]-oriented AOD, then the interaction length of the modified second AOD 702 need not be increased to such an extent as discussed above in FIG. 7.

### V. Additional Embodiments

Although it has been discussed above that the second AOD of any of the aforementioned embodiments can be provided as an [100]-oriented AOD, the first AOD of any of the aforementioned embodiments can likewise be provided as an [100]-oriented AOD. Accordingly, one or both of the first AOD and the second AOD in any of the aforementioned embodiments can be provided as an [100]-oriented AOD.

Generally, the first AOD and second AOD of the aforementioned embodiments are spaced apart from one another by some distance that is significantly larger than the wavelength of light in the beam of laser light they are operative to diffract. In other embodiments, however, the first AOD and second AOD of any of the aforementioned embodiments may be spaced apart from one another by a distance that is less than or equal to the wavelength of light in the beam of laser light. In this sense, the first AOD and second AOD (e.g., can be considered to be “optically contacted” to one another. The first and second AODs may be optically contacted to one another by any known or otherwise suitable technique. For example, the first and second AODs may be optically contacted to one another by bonding the first AOD to the second AOD according to a frit bonding process, according to a diffusion bonding process, or the like. In another example, the first and second AODs may be optically contacted to one another by polishing, cleaning and physically contacting the surfaces of the first and second AODs. As an alternative to, or in addition to, the aforementioned techniques, other optical contacting techniques may be employed, such as: solution-assisted direct bonding, chemically-activated direct bonding, or the like or any combination thereof. In another example, the first and second AODs may be optically contacted by clamping the AODs against each other.

Furthermore, although the embodiments discussed above describe the AO cell of each of the first AOD 200 and the second AOD 202 as being formed of crystalline germanium, it will be appreciated that the AO cell of each of the first AOD 200 and the second AOD 202 may be formed of any other material that employed in longitudinal-mode AODs (e.g., quartz, fused silica, LiNbO₃, GaAs, etc.).

### VI. CONCLUSION

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

1. A multi-axis beam positioner operative to deflect a beam path along which laser light along multiple axes, the beam positioner comprising:
a first acousto-optic (AO) deflector (AOD) and a second AOD arranged optically in series with each other,
wherein the first AOD is arranged and configured to deflect the beam path along a first axis of the multi-axis beam positioner,
wherein the second AOD is arranged and configured to deflect the beam path along a second axis of the multi-axis beam positioner,
wherein each of the first AOD and the second AOD has an AO cell and a transducer attached to the AO cell,
wherein the AO cell of the first AOD is formed of the same material as the AO cell of the second AOD, and
wherein the first AOD is configured differently from the second AOD.

2. The positioner of claim 1
wherein the first AOD and the second AOD are longitudinal-mode AODs, and
wherein no retarder is present between the first AOD and the second AOD.

3. The beam positioner of claim 1, wherein
the AO cell of the first AOD is formed of the same material as the AO cell of the second AOD,
a diffraction axis of the first AOD is at least substantially parallel to a first crystal axis of the material of which the AO cell of the first AOD is formed, and
a diffraction axis of the second AOD is at least substantially perpendicular to the first crystal axis the material of which the AO cell of the second AOD is formed.

4. The beam positioner of claim 1, wherein the first AOD and the second AOD each include an AO cell formed of crystalline germanium.

5. The beam positioner of claim 4, wherein a diffraction axis of the first AOD is at least substantially parallel to the [111] crystal axis of the AO cell of the first AOD.

6. The beam positioner of claim 5, wherein a diffraction axis of the first AOD is at least substantially perpendicular to the [111] crystal axis of the AO cell of the first AOD.

7. The beam positioner of claim 1, wherein
the AO cell of the first AOD is formed of the same material as the AO cell of the second AOD,
a diffraction axis of the first AOD is at least substantially parallel to a first crystal axis of the material of which the AO cell of the first AOD is formed, and
a diffraction axis of the second AOD is at least substantially perpendicular to a second crystal axis the material of which the AO cell of the second AOD is formed.

8. The beam positioner of claim 1, wherein a diffraction axis of the second AOD is at least substantially parallel to the [100] crystal axis of the AO cell of the second AOD.

9. The beam positioner of claim 1, further comprising a heat exchange mechanism thermally coupled to the second AOD, wherein the heat exchange mechanism is operative to removing heat from the second AOD.

10. The beam positioner of claim 9, wherein the heat exchange mechanism is operative to cool the AO cell of the second AOD to a temperature below 250 K.

11. The beam positioner of claim 10, wherein the temperature is below 200 K.

12. The beam positioner of claim 10, wherein the temperature is above 10 K.

13. The beam positioner of claim 1, further comprising a dehumidifier operative to prevent ambient moisture from condensing on an optical surface of at least one selected from the group consisting of the first AOD and the second AOD.

14. The beam positioner of claim 1, wherein an interaction length of the second AOD is the same as an interaction length of the first AOD.

15. The beam positioner of claim 1, wherein an interaction length of the second AOD is different from an interaction length of the first AOD.

16. The beam positioner of claim 1, wherein the AO cell of the first AOD is optically contacted to the AO cell of the second AOD such that optically contacted surfaces of the AO cells of the first and second AODs are spaced apart by a distance that is equal to or less than a wavelength of light that is diffractable by the first and second AODs.

17. A multi-axis beam positioner comprising:
a first acousto-optic (AO) deflector (AOD) and a second AOD arranged optically in series with each other; and
a heat exchanger coupled to the second AOD,
wherein the first AOD is arranged and configured to deflect the beam path along a first axis of the multi-axis beam positioner;
wherein the second AOD is arranged and configured to deflect the beam path along a second axis of the multi-axis beam positioner,
wherein each of the first AOD and the second AOD has an AO cell and a transducer attached to the AO cell,
wherein the AO cell of the second AOD is formed of crystalline germanium, and wherein the at least one heat exchanger is configured to maintain the AO cell of the second AOD at a temperature that is less than a temperature of the AO cell of the first AOD.
